(19) United States
(12) Patent Application Publication
(10) Pub. No.: US 2022/0126548 A1
(43) Pub. Date: Apr. 28, 2022

(54) ADHESIVE ARTICLE

(71) Applicant: 3M INNOVATIVE PROPERTIES COMPANY, St. Paul, MN (US)

(72) Inventors: Steven R. Austin, Oakdale, MN (US); Jayshree Seth, Woodbury, MN (US)

(21) Appl. No.: 17/647,353

(22) Filed: Jan. 7, 2022

Related U.S. Application Data
(63) Continuation of application No. 16/849,316, filed on Apr. 15, 2020.
Application No. 16/849,316 is a division of application No. 15/755,695, filed on Feb. 27, 2018, now abandoned.
(60) Provisional application No. 62/213,193, filed on Sep. 2, 2015.

(51) Int. Cl. B32B 27/06; C03C 27/10; C09J 7/40; C09J 7/26; B32B 37/12; B32B 37/10; B32B 37/00; B32B 38/06; C09J 7/38; B32B 5/18; C09J 133/08; C09J 183/04

(52) U.S. Cl. CPC B32B 27/065; C08K 7/28; C09J 7/403; C09J 7/26; B32B 37/12; B32B 37/10; B32B 37/003; B32B 37/1292; B32B 38/06; C09J 7/38; B32B 5/18; C09J 133/08; C09J 183/04; C09J 2483/00; C03C 27/10

(57) ABSTRACT

Provided are adhesive articles and related methods that use a foam layer including an acrylic polymer or silicone polymer and having a pair of opposing major surfaces. An adhesive surface is disposed on each of the opposing major surfaces and a plurality of channels extend across at least one adhesive surface. The adhesive surface defining the channels contains a pressure-sensitive adhesive having a rheology enabling the plurality of channels to essentially disappear over time when the adhesive article is compressed. Advantageously, the provided articles and methods enable high immediate bond and handling strength, a high degree of wet out, weatherability, and superior aesthetics when used with transparent or translucent substrates.

### FIELD OF THE INVENTION

Provided are adhesive articles and related methods of manufacture and use thereof. More particularly, the adhesive articles are useful for bonding glass or polymeric panels in structural glazing or architectural panel applications.

### BACKGROUND

Advanced engineering adhesives are emerging as replacements for mechanical fasteners in many commercial and industrial applications. This trend is driven, to a large degree, by engineering considerations of weight and fuel efficiency, cost and ease of manufacturing, and aesthetic preferences. Such adhesive products can provide significant bond strength and are increasingly being used not only for ornamental but also structural components.

Especially useful adhesive products include durable, high performance two-sided pressure-sensitive acrylic foam tapes. These tapes are used for many applications in the construction and architectural industry. These applications include, for example, bonding glass to metal frames in curtain wall systems and commercial windows, attachment of stiffeners and perimeter clips to architectural panels, exterior building cladding, and interior panel and trim attachment. In many cases, these tapes replace liquid adhesives, sealants, rivets, welds and other permanent fasteners. Tapes can provide immediate handling strength during fabrication resulting in increased throughput and quicker delivery/installation/occupancy.

### SUMMARY

Important considerations may arise when bonding opposing rigid substrates using an adhesive tape. For example, bonding to transparent or translucent substrates such as architectural glass or plastic can introduce aesthetic issues because air can become entrapped between the adhesive and its substrate and appear as air bubbles. While operators generally have little problem avoiding air bubbles when applying a flexible tape to the first substrate, it is generally much more difficult to avoid these bubbles when applying the now-affixed tape to a second rigid substrate.

A second concern relates to adhesive performance. A significant amount of air bubbles at the adhesive/substrate interface can impact the overall bond strength of the adhesive because it results in imperfect contact (or “wet out”). Such effects are often application-specific. For instance, at low temperatures, the materials used for conventional adhesive products do not flow as readily, even on a microscopic scale, rendering full wet out more difficult. Engineering an adhesive product that provides acceptable wet out over a wide range of temperatures while remaining dimensionally stable is thus a significant technical challenge.

The provided adhesive articles and methods significantly advance the state of the art by providing superior wet out over conventional tapes used in structural glazing or architectural panel bonding applications. Advantageously, these articles and methods provide a primary bonding component between the glazing or panel and its structural frame capable of maintaining high immediate bond and handling strength, a high degree of wet out, weatherability, and superior aesthetics.

In a first aspect, a method of making an adhesive article for bonding glass or polymeric panels in structural glazing or architectural panel applications is provided. The method comprises: providing an adhesive surface on each opposing major surface of a foam layer, the foam layer comprising an acrylic polymer or silicone polymer; and placing at least one adhesive surface in contact with a release liner having a microstructured surface to emboss the adhesive surface, thereby forming a plurality of channels extending across the adhesive surface, wherein each embossed adhesive surface comprises a pressure-sensitive adhesive having a rheology enabling the plurality of channels to essentially disappear over time when the adhesive article is compressed.

In a second aspect, an adhesive article is provided comprising: a foam layer having a pair of opposing major surfaces, the foam layer comprising an acrylic polymer or silicone polymer; and an adhesive surface disposed on each of the opposing major surfaces, wherein a plurality of channels extend across at least one adhesive surface comprising a pressure-sensitive adhesive having a rheology enabling the plurality of channels to essentially disappear over time when the adhesive article is compressed.

In a third aspect, a method of bonding a transparent or translucent glass or plastic panel using an aforementioned adhesive article is provided, comprising: disposing the adhesive article between the transparent or translucent glass or plastic panel and a substrate whereby the plurality of channels allows venting of entrapped air between the pressure-sensitive adhesive and the transparent or translucent glass or plastic panel; and applying sufficient compressive force to the adhesive article to induce flow of the pressure-sensitive adhesive whereby the channels disposed on the at least one adhesive surface essentially disappear over time.

### BRIEF DESCRIPTION OF THE DRAWINGS

FIG. 1 is a side cross-sectional view showing a partially lined adhesive article according to one exemplary embodiment.

FIG. 2 is a side cross-sectional view showing the adhesive article of FIG. 1 with liners removed.

FIG. 3 is a plan view of the unlined adhesive article of FIG. 2, showing its top surface.

FIGS. 4 and 5 are side cross-sectional views of unlined adhesive articles according to alternative embodiments.

FIGS. 6-8 are side cross-sectional views showing the top surface profile of adhesive articles according to further alternative embodiments.

In these drawings, repeated use of reference characters is intended to represent the same or analogous features or elements of the disclosure. It should be understood that numerous other modifications and embodiments can be devised by those skilled in the art, which fall within the scope and spirit of the principles of the disclosure. Figures are not necessarily drawn to scale.

### Definitions

As used herein:

“ambient conditions” means at a temperature of 24° C. and pressure of 1 atm (or 100 kPa);

“appearance” means the visual characteristics of the article as viewed from the exposed surface of the film after application of the article onto a substrate;

“bleedability” or “air-bleedability” refers to the egress of fluids, particularly air, from the interface between the adhesive and the surface of the substrate;

“embossable” refers to the ability of a pressure-sensitive adhesive layer or liner to have part of its surface raised in relief, especially by mechanical means;

“microscopic” refers to structures of small enough dimension so as to require an optic aid to the naked eye when viewed from any plane of view to determine its shape;

“microstructure” means the configuration of structures wherein at least 2 dimensions of the structures are microscopic. The topical and/or cross-sectional view of the structures must be microscopic;

“microstructured liner” refers to a liner with at least one microstructured surface, which is suitable for contact with an adhesive;

“release liner”, used interchangeably with the term “liner”, refers to a flexible sheet which after being placed in intimate contact with pressure-sensitive adhesive surface may be subsequently removed without damaging the adhesive coating;

“substrate” refers to a surface to which the pressure-sensitive adhesive coating is applied for an intended purpose;

“tape” refers to a pressure-sensitive adhesive coating applied to a backing; and

“wet out” means spreading out over and intimately contacting a surface.

### DETAILED DESCRIPTION

The adhesive articles and methods described herein are directed to the bonding of rigid or semi-rigid substrates to each other. These articles and methods enable such bonding in a manner that is convenient and efficient from the perspective of an end user. In preferred embodiments, at least one of the substrates is optically transparent or translucent and is suitable for use in structural glazing or architectural panel applications.

### Adhesive Article Constructions

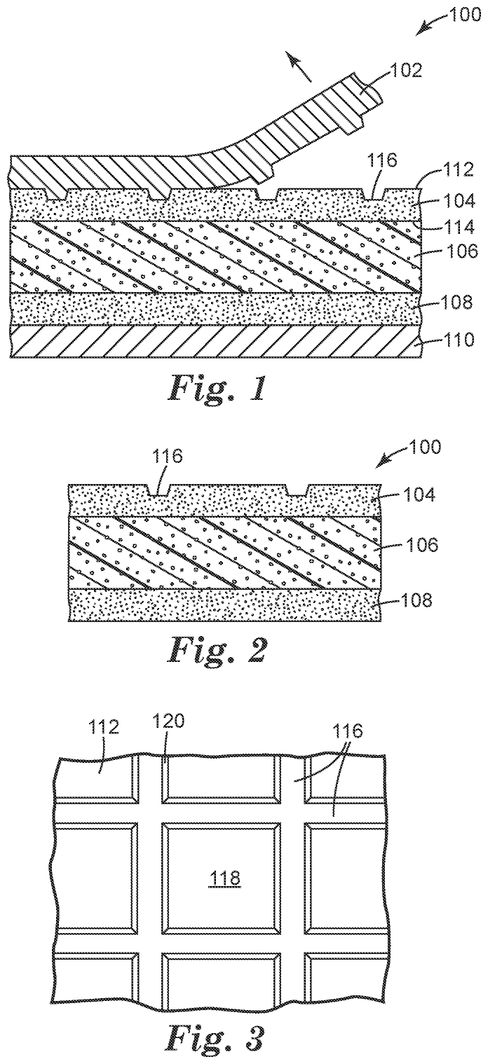

A double-sided adhesive article according to one exemplary embodiment is shown in FIG. 1 in fragmentary view and hereinafter referred to by the numeral 100. As shown, the article 100 is comprised of a plurality of component layers. The layers are, in the following order, an optional first release liner 102, an optional first adhesive skin layer 104, a foam core 106, an optional second adhesive skin layer 108, and an optional second release liner 110. Each layer extends across and continuously contacts its neighboring layer or layers.

The first and second adhesive skin layers 104, 108 provide adhesive surfaces on respective opposing sides of the foam core 106. Preferably, each of the first and second adhesive skin layers 104, 108 comprises a pressure-sensitive adhesive.

Referring again to FIG. 1, the first release liner 102 is shown in the process of being peeling away from a first major surface 112 of the first adhesive skin layer 104, which is intended to be subsequently adhered to a first substrate (not shown). The first adhesive skin layer 104 also has a second major surface 114 opposing the first major surface 112 which is in contact with the foam core 106. Disposed on the opposite side of foam core 106 is the second adhesive skin layer 108 intended to be adhered to a second substrate (also not shown). The first and second release liners 102, 110 generally remain in contact with their respective adhesive skin layers 104, 108 while being stored before use.

The first major surface 112 of the first adhesive skin layer 104 includes a microstructured surface. In preferred embodiments, the microstructured surface defines a plurality of channels 116 that extend across the first adhesive skin layer 104. As illustrated, the channels 116 are continuous open pathways or grooves that extend into the first adhesive skin layer 104 from exposed portions of the first major surface 112. These channels 116 either terminate at the peripheral portion of the first adhesive skin layer 104 or communicate with other channels that terminate at a peripheral portion of the adhesive article 100. When the article 100 is applied onto a given substrate, the pathways provide egress for air or any other fluid trapped at the interface between the first adhesive skin layer 104 and the substrate to a periphery of the article.

The channels 116 can be created by embossing or forming a microstructured surface into the adhesive. The microstructured surface may be provided, for example, by a random array or regular pattern of discrete three-dimensional structures. Individual structures can at least partially define a portion of a channel in the first major surface 112, where a plurality of structures combine to create the continuous channels on the first major surface 112. Selected patterns could include rectilinear patterns, polar patterns and other known regular patterns.

The use of the release liner 102 as shown in FIG. 1 is a preferred method for forming the microstructured adhesive of the present invention. The composition of the release liner 102 is not particularly restricted. Preferred release liner compositions include, but are not limited to, plastics such as polyethylene, polypropylene, polyesters, cellulose acetate, polyvinylchloride, and polyvinylidene fluoride, as well as paper or other substrates coated or laminated with such plastics. Embossable coated papers or thermoplastic films can be siliconized or otherwise treated to impart improved release characteristics. Techniques for providing these structures on the release liner are disclosed in U.S. Pat. No. 5,650,215 (Mazurek).

The channels 116 extending across the first adhesive skin layer 104 have a configuration that defines a specific volume per a given area of the microstructured surface of the first major surface 112. The minimum volume per unit area of the first adhesive skin layer 104 preferably ensures adequate egress for fluids at the interface of the substrate and the first adhesive skin layer 104. Preferably, the channels 116 define a volume of at least 1×10³ μm³, at least 5×10³ μm³, or at least 1×10⁴ μm³ over any 500 μm diameter circular area along a given two-dimensional plane of the first adhesive skin layer 104. In the same or alternative embodiments, the channels 116 preferably define a volume of at most 1×10⁷ μm³, at most 5×10⁶ μm³, or at most 1×10⁶ μm³ over any 500 μm diameter circular area.

Advantageously, the channels of the present invention essentially disappear over time when the article 100 is compressed against one or both of the substrates to be joined. The ability of the channels to partially or fully disappear is dependent upon the shape of the channels 116 and the rheology of the composition of the first adhesive skin layer 104.

In some embodiments, the adhesive article visually displays essentially 100% wet out at a temperature of 10° C. when or after the adhesive article is compressed. Adequate wet out enables a sufficient seal and adhesion between the article and the substrate.

The shape of the channels 116 is not particularly restricted, and can vary based on the methods used to form them. In preferred embodiments, the channels 116 have a generally “V”-shaped, “U”-shaped, rectangular, or trapezoidal cross section when viewed along their lengthwise directions. FIGS. 2 and 3 provide views of the article 100 with the release liners 102, 110 removed and showing channels 116 having a generally trapezoidal shape. The channels 116 define corresponding structures 118 formed into the first major surface 112. Side walls 120 of the structures 118 also define side walls for the channels 116.

The dimensions of the channels 116 can be further characterized by their aspect ratio. The aspect ratio is the ratio of the greatest microscopic dimension of the channel parallel to the plane of the continuous layer of adhesive to the greatest microscopic dimension of the channel perpendicular to the plane of the continuous layer of adhesive. The aspect ratio is measured by taking the cross-sectional dimensions of the channel at an angle perpendicular to the wall of the channel Depending on the specific type of channel, the limits of the aspect ratio could be from 0.1 to 20.

The thickness of the adhesive skin layers 104, 108 can depend on the adhesive composition, the type of structures used to form the microstructured surface, the type of substrate, and the thickness of the overall adhesive article 100. In a preferred embodiment, the thickness of the adhesive skin layers 104, 108 is greater than the height of the structures which comprise the microstructured surface. In some embodiments, the adhesive skin layers 104, 108 each has a thickness of at least 25 μm, at least 30 μm, at least 35 μm, at least 45 μm, or at least 55 μm. In some embodiments, each of the adhesive skin layers 104, 108 has a thickness of at most 75 μm, at most 70 μm, at most 65 μm, at most 60 μm, or at most 55 μm.

The foam core 106 is preferably made from a compressible and resilient polymeric foam composition. The thickness of the foam core 106 is generally not critical but could be selected according to the surface roughness and/or curvature of the substrates to be adhered together. The thickness of the foam core 106 can be at least 600 μm, at least 800 μm, at least 1100 μm, at least 1600 μm, or at least 2000 μm. On the upper end, the thickness of the foam core 106 can be at most 12,700 μm, at most 9000 μm, at most 6500 μm, at most 5000 μm, or at most 3000 μm.

The layers disclosed in FIG. 1 are not exhaustive. For example, one or more intermediate layers may be interposed between any two adjacent layers in the adhesive article 100 to enhance its appearance, durability, or functionality. Such layer or layers may be similar to those described above or may be structurally or chemically distinct. Distinct layers could include, for example, extruded sheets of a different polymer, metal vapor coatings, printed graphics, particles, and primers. Any additional layers may be continuous or discontinuous. In FIG. 1, for example, a tie layer may be disposed between the foam core 106 and the first or second adhesive skin layer 104, 108 to improve adhesion between these layers.

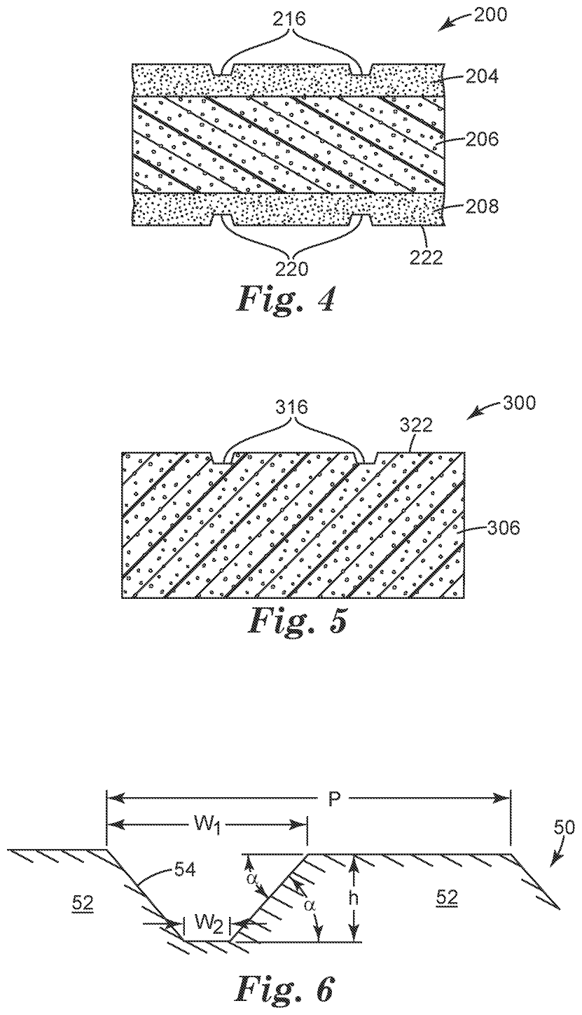

FIG. 4 shows an adhesive article 200 with release liners removed according to an alternative embodiment. The adhesive article 200 has many of the same features as adhesive article 100, such as a first adhesive skin layer 204 with a first plurality of channels 216 extending across its exposed surface, a foam core 206, and a second adhesive skin layer 208. Unlike the second adhesive skin layer 108 of the adhesive article 100, however, the second adhesive skin layer 208 has a second plurality of channels 220 extending from its exposed major surface 222 on the bottom side of the article 200. In this manner, the article 200 has a microstructured surface on both its top and bottom sides.

In some embodiments, one or both sets of channels 216, 220 can have the characteristics described with respect to the channels 116 in article 100 as described previously.

Disposing channels 216, 220 on both sides of the article 200 enables air-bleedability at the adhesive interface with respect to either of the substrates to be mutually bonded. In structural glazing and architectural panel applications, where generally both substrates are rigid and thus tend to trap air, this feature advantageously gives the installer freedom to apply the article to either substrate prior to bringing the mating surfaces together.

FIG. 5 shows an adhesive article 300 according to yet another embodiment that lacks any adhesive skin layers. In this embodiment, the adhesive article 300 is comprised of a foam layer 306 made from a pressure-sensitive adhesive foam. Here, the foam layer 306 functions alone as the adhesive that mutually bonds the substrates to be joined. A plurality of channels 316 extends across an exposed top surface 322.

While not shown in any of the figures, further embodiments can include assemblies including any of the aforementioned adhesive articles. For example, such an adhesive article may be pre-bonded to either the frame or glass/plastic panel for the convenience of the end user. In these embodiments, a release liner could be used to protect the exposed adhesive skin surface.

### Alternative Microstructured Surfaces

The shape of the structures embossed or formed into the adhesive surfaces, whether it is an adhesive skin layer, adhesive foam, or combination thereof, can provide a variety of microstructured surfaces. Exemplary shapes include, but are not limited to, hemispheres, prisms (such as square prisms, rectangular prisms, cylindrical prisms and other similar polygonal features), pyramids, or ellipsoids, and combinations thereof. Preferred shapes include hemispheres, prisms, and pyramids. Each individual structure can have a height of greater than 3 micrometers but less than the total thickness of the first adhesive skin layer 104, and preferably from 3 micrometers to 50 micrometers.

Optionally, some of the structures may be truncated to provide a surface for additional structures, to control the contact surface of the adhesives, and/or to improve the wet out of the adhesive. Structures that could be used include a quadrangle pyramids and truncated quadrangle pyramids. Double featured structures are also suitable for use in the provided adhesive articles. Advantageously, the stacking or use of two structures can enhance the positionability of the article by further reducing the initial contacting surface of the adhesive.

Further options and advantages associated with exemplary structures are described, for example, in U.S. Pat. No. 6,524,675 (Mikami et al.), U.S. Pat. No. 6,838,142 (Yang et al.), and U.S. Pat. No. 7,276,278 (Kamiyama).

Optionally, the structures are arranged at a pitch (average value of a distance between similar structural points of adjacent structures) of 400 μm or less, and preferably 300 μm or less. Use of pitches smaller than 400 μm can be beneficial because it can enable the pattern of features to disappear from the surface of the film after application and enhancing the aesthetics of the bonded assembly.

FIGS. 6-8 show alternative shapes and dimensions for the microstructured surfaces that may be implemented in the provided adhesive articles.

FIG. 6 is a side cross-sectional view of a pressure-sensitive adhesive 50 having a plurality of structures 52. The pitch P between the structures 52 need not be particularly restricted, but is preferably at most 400 μm. In preferred embodiments, the height h of each structure 52 from the channel 54 (i.e. channel depth) can be at least 3 μm, at least 5 μm, at least 7 μm, at least 8 μm, or at least 10 μm. In preferred embodiments, the height h can be at most 50 μm, at most 45 μm, at most 40 μm, at most 35 μm, or at most 30 μm.

The length W₁ of the upside of the channel 54 can range from 1 μm to the size of the pitch P and furthermore a length W₂ of the base of the channel 54 can range from 0 μm to a length sufficient to provide a base angle α of the feature within a range from 1° to 90°. In preferred embodiments, the aspect ratio of the corresponding channel is no greater than 20.

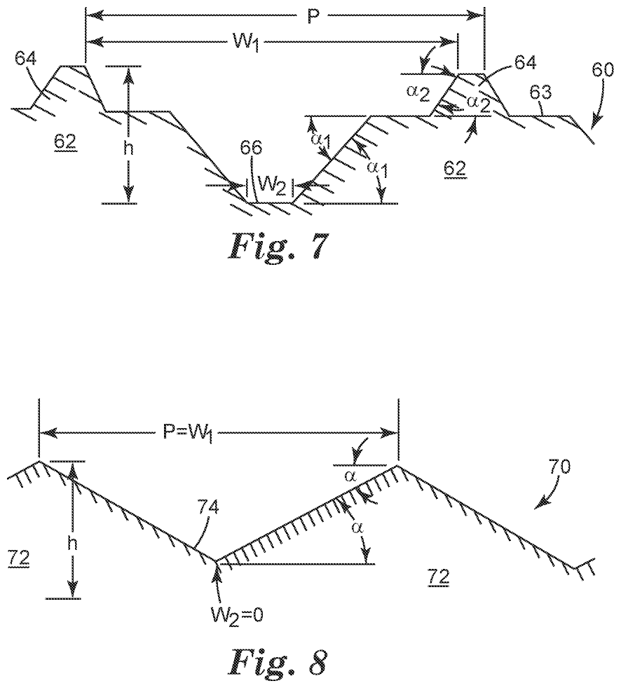

FIG. 7 shows an adhesive 60 having a truncated structure 62 with a second structure 64 positioned on an upper surface 63 of the truncated structure 62. In this embodiment, the pitch P measured from corresponding edges of second structure 64 is at most 400 μm. The height of each structure from the base of the channel 66 preferably ranges from 1 μm to 30 μm. The length W₁ of the upside of the channel 66 can range from 1 μm to the size of the pitch P and furthermore a length W₂ of the base of the channel 66 can range from 0 μm to a length sufficient provide a base angle α₁ of the structure 62 in a range from 1° to 90°. A base angle α₂ of the second structure 64 can range from 1° to 90°.

FIG. 8 shows an adhesive layer 70 having structures 72 in the shape of a quadrangular pyramid. In this embodiment, the pitch P between the structures 72 is equal to the length W₁ of the upside of the channel 74 and is at most 400 μm. The height h of each structure 72 from the base of the channel 74 is within a range from 3 to 30 μm. In this particular embodiment, the length W₂ of the base of the channel 74 is 0 μm.

### Adhesive Compositions

Useful pressure-sensitive adhesives include those capable of retaining microstructured features on an exposed surface after being embossed with a microstructured molding tool, backing or liner, or after being coated on a microstructured molding tool, backing or liner from which it is then removed. The pressure-sensitive adhesive selected for a given application is dependent upon the type of substrate the article will be applied onto and the microstructuring method employed in producing the adhesive-backed article. The microstructured pressure-sensitive adhesives are preferably capable of retaining their microstructured surfaces for a time sufficient to allow convenient application of the adhesive article by the end user.

Any pressure-sensitive adhesive is suitable for the invention. Adhesives are typically selected based upon the type of substrate that they are to be adhered to. Classes of pressure-sensitive adhesives include acrylics, tackified rubber, tackified synthetic rubber, ethylene vinyl acetate, silicone polymers, and the like. Suitable acrylic and silicone adhesives are disclosed, for example, in U.S. Pat. No. 3,239,478 (Harlan), U.S. Pat. No. 3,935,338 (Robertson), U.S. Pat. No. 5,169,727 (Boardman), RE24,906 (Ulrich), U.S. Pat. No. 4,952,650 (Young et al.), U.S. Pat. No. 4,181,752 (Martens et al.), and U.S. Pat. No. 8,298,367 (Beger et al.).

Polymers useful for the acrylic pressure-sensitive adhesive layer includes acrylate and methacrylate polymers and copolymers. Such polymers can be made by polymerizing one or more monomeric acrylic or methacrylic esters of non-tertiary alkyl alcohols, with the alkyl groups having from 1 to 20 carbon atoms (for example, from 3 to 18 carbon atoms). Suitable acrylate monomers include, for example, methyl acrylate, ethyl acrylate, n-butyl acrylate, lauryl acrylate, 2-ethylhexyl acrylate, cyclohexyl acrylate, iso-octyl acrylate, octadecyl acrylate, nonyl acrylate, decyl acrylate, and dodecyl acrylate. The corresponding methacrylates can be used as well. Also useful are aromatic acrylates and methacrylates, for example, benzyl acrylate and cyclobenzyl acrylate. Optionally, one or more monoethylenically unsaturated co-monomers may be polymerized with the acrylate or methacrylate monomers. The particular type and amount of co-monomer is selected based upon the desired properties of the polymer.

One group of useful co-monomers includes those having a homopolymer glass transition temperature greater than the glass transition temperature of the (meth)acrylate (i.e., acrylate or methacrylate) homopolymer. Examples of suitable co-monomers falling within this group include acrylic acid, acrylamides, methacrylamides, substituted acrylamides (such as N,N-dimethyl acrylamide), itaconic acid, methacrylic acid, acrylonitrile, methacrylonitrile, vinyl acetate, N-vinyl pyrrolidone, isobornyl acrylate, cyano ethyl acrylate, N-vinylcaprolactam, maleic anhydride, hydroxyalkyl (meth)-acrylates, N,N-dimethyl aminoethyl (meth)acrylate, N,N-diethylacrylamide, beta-carboxyethyl acrylate, vinyl esters of neodecanoic, neononanoic, neopentanoic, 2-ethylhexanoic, or propionic acids, vinylidene chloride, styrene, vinyl toluene, and alkyl vinyl ethers. A second group of monoethylenically unsaturated co-monomers that may be polymerized with the acrylate or methacrylate monomers includes those having a homopolymer glass transition temperature (T_{g}) less than the glass transition temperature of the acrylate homopolymer. Examples of suitable co-monomers falling within this class include ethyloxyethoxyethyl acrylate (T_{g}=−71° C.) and a methoxypolyethylene glycol 400 acrylate (T_{g}=−65° C.; available from Shin Nakamura Chemical Co., Ltd., Wakayama, Japan, under the trade designation NK Ester AM-90G). Blends of acrylic pressure-sensitive adhesive polymers and rubber based adhesives in particular, elastomeric block copolymer-based adhesives (for example, tackified SIS or SBS based block copolymer adhesives), may also be used as an acrylic pressure-sensitive adhesive layer such as is described in PCT International Publication No. WO 01/57152 (Khandpur et al.).

The adhesive polymer can be dispersed in solvent or water and coated onto the release liner and dried, and optionally crosslinked. If a solvent-borne or water-borne pressure-sensitive adhesive composition is employed, then the adhesive layer generally undergoes a drying step to remove all or a majority of the carrier liquid. Additional coating steps may be necessary to achieve a smooth surface. The adhesives may also be hot melt coated onto the liner or microstructured backing. Additionally, monomeric pre-adhesive compositions can be coated onto the liner and polymerized with an energy source such as heat, UV radiation, or electron beam radiation.

As a further option, the pressure-sensitive adhesive can optionally include one or more additives. Depending on the method of polymerization, the coating method, and end user application, such additives may include initiators, fillers, plasticizers, tackifiers, chain transfer agents, fibrous reinforcing agents, woven and non-woven fabrics, foaming agents, antioxidants, stabilizers, fire retardants, viscosity enhancing agents, coloring agents, and mixtures thereof.

The rheology of the adhesive can be characterized by its Tangent Delta value, or the ratio of the loss shear modulus (G″) over the storage shear modulus (G′) of the adhesive material. In some embodiments, the adhesive displays a Tangent Delta value of at most 0.5, at most 0.48, at most 0.45, at most 0.42, at most 0.4, or at most 0.35, as measured by uniaxial dynamic mechanical analysis according to known methods at a frequency of 1 Hz under ambient conditions.

### Foam Compositions

In preferred embodiments, the composition of the foam core 106 comprises an acrylic polymer or silicone polymer. Further preferred foam compositions include foams that are essentially free of any polyurethanes, which tend to degrade when exposed to ultraviolet light. For example, the foam composition could have less than 5 percent, less than 3 percent, less than 1 percent, less than 0.5 percent or less than 0.1 percent polyurethanes.

Acrylic and silicone foams are useful due to their ultraviolet light stability, conformability, and ability to distribute stress. The acrylic polymer can be, for example, an acrylic acid ester of a non-tertiary alcohol having from 1 to 18 carbon atoms. In some embodiments, the acrylic acid ester includes a carbon-to-carbon chain having 4 to 12 carbon atoms and terminates at the hydroxyl oxygen atom, the chain containing at least half of the total number of carbon atoms in the molecule.

Certain useful acrylic acid esters are polymerizable to a tacky, stretchable, and elastic adhesive. Examples of acrylic acid esters of nontertiary alcohols include but are not limited to 2-methylbutyl acrylate, isooctyl acrylate, lauryl acrylate, 4-methyl-2-pentyl acrylate, isoamyl acrylate, sec-butyl acrylate, n-butyl acrylate, n-hexyl acrylate, 2-ethylhexyl acrylate, n-octyl acrylate, n-decyl acrylate, isodecyl acrylate, isodecyl methacrylate, and isononyl acrylate. Suitable acrylic acid esters of nontertiary alcohols include, for example, 2-ethylhexyl acrylate and isooctylacrylate.

To enhance the strength of the foam, the acrylic acid ester may be copolymerized with one or more monoethylenically unsaturated monomers that have highly polar groups. Such monoethylenically unsaturated monomer such as acrylic acid, methacrylic acid, itaconic acid, acrylamide, methacrylamide, N-substituted acrylamides (for example, N,N-dimethyl acrylamide), acrylonitrile, methacrylonitrile, hydroxyalkyl acrylates, cyanoethyl acrylate, N-vinylpyrrolidone, N-vinylcaprolactam, and maleic anhydride. In some embodiments, these copolymerizable monomers are used in amounts of less than 20% by weight of the adhesive matrix such that the adhesive is tacky at ordinary room temperatures. In some cases, tackiness can be preserved at up to 50% by weight of N-vinylpyrrolidone.

Especially useful are acrylate copolymers comprising at least 6% by weight acrylic acid, and in other embodiments, at least 8% by weight, or at least 10% by weight acrylic acid, each based on the total weight of the monomers in the acrylate copolymer. The adhesive may also include small amounts of other useful copolymerizable monoethylenically unsaturated monomers such as alkyl vinyl ethers, vinylidene chloride, styrene, and vinyltoluene.

Enhancement of the cohesive strength of the foam may also be achieved through the use of a crosslinking agent such as 1,6-hexanediol diacrylate, with a photoactive triazine crosslinking agent such as taught in U.S. Pat. No. 4,330,590 (Vesley) and U.S. Pat. No. 4,329,384 (Vesley et al.), or with a heat-activatable crosslinking agent such as a lower-alkoxylated amino formaldehyde condensate having C₁₋₄ alkyl groups—for example, hexamethoxymethyl melamine or tetramethoxymethyl urea or tetrabutoxymethyl urea. Crosslinking may be achieved by irradiating the composition with electron beam (or “e-beam”) radiation, gamma radiation, or x-ray radiation. Bisamide crosslinkers may be used with acrylic adhesives in solution.

The polymer used in the foam can be prepared by any suitable polymerization method. Suitable polymerization methods include, but are not limited to, photopolymerization, thermal polymerization, or ionizing radiation polymerization. These methods can be carried out in solution, emulsion, or bulk without solvent. Bulk polymerization methods are described in U.S. Pat. No. 5,804,610 (Hamer et al.). Optionally, photopolymerizable monomers may be partially polymerized to a viscosity of from 1000 to 40,000 cps to facilitate coating. Alternatively, partial polymerization can be effected by heat. If desired, viscosity can also be adjusted by mixing monomers with a thixotropic agent such as fumed silica.

The weight average molecular weight of the polymer in the foam before crosslinking can be at least 600,000 g/mol, at least 800,000 g/mol, or at least 1,000,000 g/mol.

Photopolymerization can take place in an inert atmosphere such as under a blanket of nitrogen or argon gas. Alternatively, an inert environment can be achieved by temporarily covering the photopolymerizable coating with a plastic film transparent to ultraviolet radiation, and irradiating the coating through the film. If the polymerizable coating is not covered during photopolymerization, the permissible oxygen content of the inert atmosphere can be increased by mixing into the photopolymerizable composition an oxidizable tin compound such as disclosed in U.S. Pat. No. 4,303,485 (Levens), which can enable relatively thicker coatings to be polymerized in air.

Optionally, the foam contains one or more additives. Such additives can include, for example, fillers, antioxidants, viscosity modifiers, pigments, tackifying resins, fibers, flame retardants, antistatic and slip agents, thermally conductive particles, electrically conductive particles, continuous microfibers, filaments, and mixtures thereof.

The polymer used to make the foam may be initially coated onto and polymerized against a flexible backing sheet (for example, a release liner) that has a low-adhesion surface from which the polymerized layer is readily removable and almost always is self-sustaining. If the opposite face of the backing sheet also has a low-adhesion surface, the backing sheet with its polymerized layer may be wound up in roll form for storage prior to assembly of the finished adhesive article.

In some embodiments, the foam is made from a silicone polymer. Suitable silicone polymers can include, for example, an MQ resin containing a resinous core and nonresinous polyorganosiloxane group terminated with a silicon-bonded hydroxyl group; a treated MQ resin, and a polydiorganosiloxane terminated with a condensation reactable group. Such compositions may be used for structural glazing applications, as described in U.S. Pat. No. 8,298,367 (Beger et al.).

Generally, the foam may be an open cell foam, a closed cell foam, or combination thereof. In some embodiments, the foam is a syntactic foam containing hollow microspheres, for example, hollow glass microspheres. Useful hollow glass microspheres include those having a density of less than 0.4 g/cm and having a diameter of from 5 to 200 micrometers. The microspheres may be clear, coated, stained, or a combination thereof. The microspheres typically comprise from 5 to 65 volume percent of the foam composition. Examples of useful acrylic foams thus made are disclosed in U.S. Pat. No. 4,415,615 (Esmay et al.) and U.S. Pat. No. 6,103,152 (Gehlsen et al.).

In some embodiments, foams may be formed by blending expanded polymeric microspheres into a polymerizable composition. In some embodiments, foams may be formed by blending expandable polymeric microspheres into a composition and expanding the microspheres. An expandable polymeric microsphere includes a polymer shell and a core material in the form of a gas, liquid, or combination thereof. Upon heating to a temperature at or below the melt or flow temperature of the polymeric shell, the polymer shell expands to form the microsphere. Suitable core materials include propane, butane, pentane, isobutane, neopentane, isopentane, and combinations thereof. The thermoplastic resin used for the polymer microsphere shell can influence the mechanical properties of the foam, and the properties of the foam may be adjusted by the choice of microsphere, or by using mixtures of different types of microspheres. Examples of commercially available expandable microspheres include those available under the trade designation Expancel™, from Akzo Nobel Pulp and Performance Chemicals AB, Sundsvall, Sweden. Methods of making foams containing expandable polymeric microspheres and particulars of these microspheres are described in U.S. Pat. No. 6,103,152 (Gehlsen et al.).

Foams may also be prepared by forming gas voids in a composition using a variety of mechanisms including, for example, mechanical mechanisms, chemical mechanisms, and combinations thereof. Useful mechanical foaming mechanisms include, for example, agitating (for example, shaking, stirring, or whipping the composition, and combinations thereof), injecting gas into the composition (for example, inserting a nozzle beneath the surface of the composition and blowing gas into the composition), and combinations thereof. Methods of making the foams with voids formed via a foaming agent are described in U.S. Pat. No. 6,586,483 (Kolb et al.).

In exemplary embodiments, the foams have a foam density of from 320 kg/m³ to 800 kg/m³, from 400 kg/m³ to 720 kg/m³, or from 400 kg/m³ to 641 kg/m³.

### Methods of Use

The provided adhesive articles can be applied according to any of a number of bonding methods. Such bonding methods are especially suitable for adhering glass or polymeric panels used for structural glazing or architectural panels.

In general, a transparent or translucent glass or plastic panel can be bonded by stripping off any release liners from the adhesive article and disposing it between the transparent or translucent glass or plastic panel and a complemental frame (or any other second substrate). Optionally, the plurality of channels are disposed on the adhesive surface that faces the glass or plastic panel, thus allowing venting of any entrapped air between the pressure-sensitive adhesive and the transparent or translucent glass or plastic panel. To secure the bond, the end user applies sufficient compressive force to the adhesive article to induce flow of the pressure-sensitive adhesive such that the channels on the adhesive surface essentially disappear over time. Preferably, sufficient compressive force can be easily provided by hand, but a roller or other device can optionally be used to assist in this process.

The above can be implemented by removing the first release liner (if present), mounting the adhesive article initially to the frame (or second substrate), removing the second release liner, and then placing the panel to be bonded onto the frame/adhesive assembly.

As an alternative, the orientation of the channels in the adhesive article can be reversed such that the plurality of channels is oriented toward the frame (or second substrate). In these cases, it is preferred that the adhesive surface without channels is applied first to the glass or plastic panel and the panel/adhesive assembly then mounted to the frame.

As described above and illustrated in FIG. 5, the adhesive article may have a plurality channels formed into the exposed adhesive surface on each of the opposing sides of the article. In this case, air-bleedability is available on both adhesive surfaces and thus the order in which the tape is applied may not matter. For example, and end user can apply the adhesive article to either the panel or the frame first without concern for substantial air entrapment at either adhesive/substrate interface.

It is preferable for the channels formed into the adhesive surface(s) to eventually disappear after bonding. This feature is advantageous not only from an aesthetic perspective but also because the presence of persistent channels can increase the risk that moisture, cleaning fluids, or other liquids might wick into the bond interface over time to the detriment of bond strength. In some embodiments, the channels disappear over a period of up to 5 minutes, up to 1440 minutes, or up to 2880 minutes after the corresponding substrates have been adhesively bonded to each other.

While not intended to be exhaustive, a list of non-limiting embodiments are enumerated as follows:

1. A method of making an adhesive article for bonding glass or polymeric panels in structural glazing or architectural panel applications, the method comprising: providing an adhesive surface on each opposing major surface of a foam layer, the foam layer comprising an acrylic polymer or silicone polymer; and placing at least one adhesive surface in contact with a release liner having a microstructured surface to emboss the adhesive surface, thereby forming a plurality of channels extending across the adhesive surface, wherein each embossed adhesive surface comprises a pressure-sensitive adhesive having a rheology enabling the plurality of channels to essentially disappear over time when the adhesive article is compressed.
2. The method of embodiment 1, wherein the pressure-sensitive adhesive displays a Tangent Delta value of at most 0.5 as measured by uniaxial dynamic mechanical analysis at 1 radian/sec at a temperature of 100° C. and frequency of 1 Hz.
3. The method of embodiment 2, wherein the pressure-sensitive adhesive displays a Tangent Delta value of at most 0.45 as measured by uniaxial dynamic mechanical analysis at 1 radian/sec at a temperature of 100° C. and frequency of 1 Hz.
4. The method of embodiment 3, wherein the pressure-sensitive adhesive displays a Tangent Delta value of at most 0.4 as measured by uniaxial dynamic mechanical analysis at 1 radian/sec at a temperature of 100° C. and frequency of 1 Hz.
5. The method of any one of embodiments 1-4, wherein the foam layer is essentially free of polyurethanes.
6. The method of any one of embodiments 1-5, wherein the foam layer comprises a foam core disposed between a pair of adhesive skin layers, each adhesive skin layer comprising a pressure-sensitive adhesive.
7. The method of embodiment 6, wherein the foam core comprises a pressure-sensitive adhesive foam.
8. The method of embodiment 6 or 7, wherein the foam core is a syntactic foam containing glass microspheres.
9. The method of any one of embodiments 6-8, wherein the adhesive skin layers each have a thickness ranging from 25 μm to 75 μm.
10. The method of embodiment 9, wherein the adhesive skin layers each have a thickness ranging from 35 μm to 70 μm.
11. The method of embodiment 10, wherein the adhesive skin layers each have a thickness ranging from 45 μm to 60 μm.
12. The method of any one of embodiments 6-11, wherein the foam core has a thickness ranging from 600 μm to 12,700 μm.
13. The method of embodiment 12, wherein the foam core has a thickness ranging from 1100 μm to 6500 μm.
14. The method of embodiment 13, wherein the foam core has a thickness ranging from 2000 μm to 3000 μm.
15. The method of any one of embodiments 6-14, wherein the foam core has a density ranging from 320 kg/m³ to 800 kg/m³.
16. The method of embodiment 15, wherein the foam core has a density ranging from 400 kg/m³ to 720 kg/m³.
17. The method of embodiment 16, wherein the foam core has a density ranging from 400 kg/m³ to 640 kg/m³.
18. The method of any one of embodiments 6-17, wherein one or both of the adhesive skin layers comprises the acrylic polymer or silicone polymer.
19. The method of any one of embodiments 1-5, wherein the foam layer comprises a pressure-sensitive adhesive foam, each adhesive surface being defined by respective opposing major surfaces of the pressure-sensitive adhesive foam.
20. The method of any one of embodiments 1-19, wherein the acrylic polymer comprises alkyl (meth)acrylates whose alkyl moiety having 1 to 20 carbon atoms, including methyl (meth)acrylates, ethyl (meth)acrylates, propyl (meth)acrylates, isopropyl (meth)acrylates, butyl (meth)acrylates, isobutyl (meth)acrylates, s-butyl (meth)acrylates, t-butyl (meth)acrylates, pentyl (meth)acrylates, isopentyl (meth)acrylates, hexyl (meth)acrylates, heptyl (meth)acrylates, octyl (meth)acrylates, 2-ethylhexyl (meth)acrylates, isooctyl (meth)acrylates, nonyl (meth)acrylates, isononyl (meth)acrylates, decyl (meth)acrylates, isodecyl (meth)acrylates, undecyl (meth)acrylates, dodecyl (meth)acrylates, tridecyl (meth)acrylates, tetradecyl (meth)acrylates, pentadecyl (meth)acrylates, hexadecyl (meth)acrylates, heptadecyl (meth)acrylates, octadecyl (meth)acrylates, nonadecyl (meth)acrylates, and eicosyl (meth)acrylates.
21. The method of any one of embodiments 1-20, wherein the channels have a depth ranging from 3 μm to 50 μm.
22. The method of embodiment 21, wherein the channels have a depth ranging from 7 μm to 40 μm.
23. The method of embodiment 22, wherein the channels have a depth ranging from 10 μm to 30 μm.
24. The method of any one of embodiments 1-23, wherein the channels define a volume ranging from 1×10³ μm³ to 1×10⁷ μm³ for any given 500 μm diameter circular area along the surface of the pressure-sensitive adhesive.
25. The method of embodiment 24, wherein the channels define a volume ranging from 5×10³ μm³ to 5×10⁶ μm³ for any given 500 μm diameter circular area along the surface of the pressure-sensitive adhesive.
26. The method of embodiment 25, wherein the channels define a volume ranging from 1×10⁴ μm³ to 1×10⁶ μm³ for any given 500 μm diameter circular area along the surface of the pressure-sensitive adhesive.
27. An adhesive article made using the method of any one of embodiments 1-26.
28. An adhesive article comprising: a foam layer having a pair of opposing major surfaces, the foam layer comprising an acrylic polymer or silicone polymer; and an adhesive surface disposed on each of the opposing major surfaces, wherein a plurality of channels extend across at least one adhesive surface, the at least one adhesive surface comprising a pressure-sensitive adhesive having a rheology enabling the plurality of channels to essentially disappear over time when the adhesive article is compressed.
29. The adhesive article of embodiment 28, wherein the foam layer has a thickness ranging from 1100 μm to 6500 μm.
30. The adhesive article of embodiment 29, wherein the foam layer has a thickness ranging from 2000 μm to 3000 μm.
31. The adhesive article of any one of embodiments 28-30, wherein the pressure-sensitive adhesive displays a Tangent Delta value of at most 0.5 as measured by uniaxial dynamic mechanical analysis at 1 radian/sec at a temperature of 100° C. and frequency of 1 Hz.
32. The adhesive article of embodiment 31, wherein the pressure-sensitive adhesive displays a Tangent Delta value of at most 0.45 as measured by uniaxial dynamic mechanical analysis at 1 radian/sec at a temperature of 100° C. and frequency of 1 Hz.
33. The adhesive article of embodiment 32, wherein the pressure-sensitive adhesive displays a Tangent Delta value of at most 0.4 as measured by uniaxial dynamic mechanical analysis at 1 radian/sec at a temperature of 100° C. and frequency of 1 Hz.
34. The adhesive article of any one of embodiments 27-33, further comprising a transparent or translucent glass or plastic panel extending across and contacting the at least one adhesive surface.
35. A method of bonding a transparent or translucent glass or plastic panel using the adhesive article of any one of embodiments 27-33, comprising: disposing the adhesive article between the transparent or translucent glass or plastic panel and a substrate whereby the plurality of channels allows venting of entrapped air between the pressure-sensitive adhesive and the transparent or translucent glass or plastic panel; and applying sufficient compressive force to the adhesive article to induce flow of the pressure-sensitive adhesive whereby the channels disposed on the at least one adhesive surface essentially disappear over time.
36. The method of embodiment 35, wherein the adhesive article visually displays essentially 100% wet out at a temperature of 10° C. when or after the adhesive article is compressed under hand pressure.

### EXAMPLES

Objects and advantages of this disclosure are further illustrated by the following non-limiting examples. The particular materials and amounts thereof recited in these examples, as well as other conditions and details, should not be construed to unduly limit this disclosure. Unless otherwise noted, all parts, percentages, ratios, etc. in the Examples and the rest of the specification are by weight.

Materials used in these Examples are given in Table 1 below.

TABLE 1
Materials

| Designation | Description | Source |
|---|---|---|
| RL-1 | A polyolefin liner, 5 mil (approximately 127 | 3M Co., St. Paul, MN |
| | micrometers) thick, standard liner for “3M VHB | |
| | STRUCTURAL GLAZING TAPE B23F” | |
| RL-2 | A microstructured polyethylene-coated kraft | 3M Co., St. Paul, MN |
| | paper (“PCK”) liner, height of ridges 10 to 17 | |
| | micrometers; pitch 197 micrometers (129 lines | |
| | per inch (“lpi”)) | |
| RL-3 | A microstructured PCK liner, height of ridges | 3M Co., St. Paul, MN |
| | 20-24 micrometers; pitch of approximately 1693 | |
| | micrometers (15 lpi) | |
| RL-4 | A microstructured, polyethylene-coated | 3M Co., St. Paul, MN |
| | polyethylene terephthalate) (“PCPET”) liner, | |
| | height of ridges 20-24 micrometers; pitch of | |
| | approximately 1693 micrometers (15 lpi) | |
| RL-5 | A microstructured PCK liner having a ridge | 3M Co., St. Paul, MN |
| | height of 20-27 micrometers and a pitch of | |
| | approximately 292 micrometers (87 lpi) | |
| VHB SGT B23F | A pressure-sensitive tape for structural glazing | 3M Co., St. Paul, MN |
| | applications, 1 inch (2.54 cm) wide, available | |
| | under the trade designation “3M VHB | |
| | STRUCTURAL GLAZING TAPE B23F” | |
| PC panel | Clear polycarbonate panel, 0.25 inch (0.64 cm) | Bayer MaterialScience, |
| | thick, available under the trade designation | Baytown, TX |
| | “MAKRALON GP” | |

Release liners RL-2 to RL-5 were liners having microstructure characteristics, as summarized in Table 2. Release RL-1 was not treated to introduce microstructure characteristics, and was used as a comparative example

TABLE 2
Release Liners

| | | Height of ridges, | Pitch, | |
|---|---|---|---|---|
| Designation | Material | micrometers | micrometers | Reference |
| RL-2 | PCK | 10 to 17 | 197 | U.S. Pat. No. 6,524,675, see |
| | | | | Example 6, except using PCK |
| | | | | and height of ridges 10 to 17 |
| | | | | micrometers instead of 25 |
| | | | | micrometers |
| RL-3 | PCK | 20 to 24 | 1693 | U.S. Pat. No. 6,772,686, see |
| | | | | Example 1, except using PCK, |
| | | | | and pitch = 1693 micrometers |
| | | | | instead of 1270 micrometers |
| RL-4 | PCPET | 20 to 24 | 1693 | U.S. Pat. No. 6,772,686, see |
| | | | | Example 1, except using |
| | | | | PCPET, and pitch = 1693 |
| | | | | micrometers instead of 1270 |
| | | | | micrometers |
| RL-5 | PCK | 20 to 27 | 292 | U.S. Pat. No. 6,524,675, see |
| | | | | Example 8, except using PCK |

### Preparation of Tape/Release Liner Samples

Each of release liners RL-1 to RL-5 was placed in contact with an exposed adhesive surface of VHB SGT B23F pressure-sensitive tape (1 inch wide tape on liner that was approximately 0.5 inch wider around all sides. Steel metal plates (0.25 inch thick, or approximately 0.64 cm thick) with steel weights were then stacked onto the pressure-sensitive tape/release liner samples (“tape/liner samples”) to give a pressure of 4 psi (28 kPa) for 7 days at ambient room temperature conditions (24° C.).

### Preparation of Examples 1 to 16 (EX-1 to EX-16) and Comparative Examples 1 to 4 (CE-1 to CE-4)

Tape/liner samples RL-1 to RL-5 were conditioned at one of the following temperature conditions after the 7-day room ambient (room temperature) conditioning step:
1. 50° F. (10° C.)
2. 75° F. (24° C.)
3. 90° F. (32° C.)

Substrate panels of clear polycarbonate (“PC”) or glass, which were 0.25 inches (0.64 centimeters) thick, were also conditioned at one of the above temperature conditions, in preparation for lamination of the substrate panel with a tape/liner sample having the same temperature condition.

Tape/line samples and substrates panels were conditioned at the indicated temperature until it was verified with an infrared temperature gun (available from 3M Co., St. Paul, Minn., under the trade designation “IR-500 INFRARED THERMOMETER”) that the tape/liner samples and substrates were at the selected temperature prior to application of the tape/liner sample to the substrate panel. Then, the liner was peeled from the tape, and the tape was placed onto the substrate panel with the adhesive side facing the substrate panel, and laminated onto the substrate using a 15 pound (6.8 kg) weighted roller, rolled at 12 inches (30 cm) per minute, for two passes over the tape.

After application of the tape sample to substrate panel, the resulting construct was visually examined for entrapped air (“air bubbles”) and any visible pattern from the release liner in the adhesive. The test conditions and results were as summarized in Table 3.

TABLE 3

| | | | | Visual Appearance | | | |
|---|---|---|---|---|---|---|---|
| | | | | Initial | | 2 days | |
| | | | | Air bubbles, | Liner | Air bubbles, | Liner |
| | Release | Temperature | Substrate | percent of | pattern | percent of | pattern |
| Sample | Liner | Condition | Panel | area | visible? | area | visible? |
| CE-1 | RL-1 | 10° C. | PC | ~5% | NA | ~5% | NA |
| CE-2 | RL-1 | 10° C. | glass | ~5% | NA | ~5% | NA |
| CE-3 | RL-1 | 24° C. | glass | ~15% | NA | ~15% | NA |
| CE-4 | RL-1 | 32° C. | glass | ~25% | NA | ~25% | NA |
| EX-1 | RL-2 | 10° C. | PC | No | No | No | No |
| EX-2 | RL-2 | 10° C. | glass | No | No | No | No |
| EX-3 | RL-2 | 24° C. | glass | No | No | No | No |
| EX-4 | RL-2 | 32° C. | glass | No | No | No | No |
| EX-5 | RL-3 | 10° C. | PC | ~5% | Yes | No | Yes |
| EX-6 | RL-3 | 10° C. | glass | ~10% | Yes | No | Yes |
| EX-7 | RL-3 | 24° C. | glass | ~5% | Yes | No | Yes |
| EX-8 | RL-3 | 32° C. | glass | <5% | Yes | No | No |
| EX-9 | RL-4 | 10° C. | PC | ~10% | Yes | No | Yes |
| EX-10 | RL-4 | 10° C. | glass | ~20% | Yes | No | Yes |
| EX-11 | RL-4 | 24° C. | glass | ~75% | Yes | No | Yes |
| EX-12 | RL-4 | 32° C. | glass | ~10% | Yes | No | No |
| EX-13 | RL-5 | 10° C. | PC | ~10% | No | <5% | No |
| EX-14 | RL-5 | 10° C. | glass | ~25% | No | ~5% | No |
| EX-15 | RL-5 | 24° C. | glass | <5% | No | ~5% | No |
| EX-16 | RL-5 | 32° C. | glass | No | No | No | No |

“NA” = not applicable

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

What is claimed is:

1. A method of making an adhesive article for bonding glass or polymeric panels in structural glazing or architectural panel applications, the method comprising:
providing an adhesive surface on each opposing major surface of a foam layer, the foam layer comprising an acrylic polymer or silicone polymer; and
placing at least one adhesive surface in contact with a release liner having a microstructured surface to emboss the adhesive surface, thereby forming a plurality of channels extending across the adhesive surface, wherein the channels are arranged at a pitch (average value of a distance between similar structural points of adjacent structures) of 400 μm or less,
wherein each embossed adhesive surface comprises a pressure-sensitive adhesive having a rheology enabling the plurality of channels to essentially disappear over time such that the adhesive article visually displays essentially 100% wet out at a temperature of 10° C. after the adhesive article is compressed by sufficient compressive force to induce flow of the pressure-sensitive adhesive.

2. The method of claim 1, wherein the pressure-sensitive adhesive displays a Tangent Delta value of at most 0.5 as measured by uniaxial dynamic mechanical analysis at 1 radian/sec at a temperature of 100° C. and frequency of 1 Hz.

3. The method of claim 1, wherein the foam layer is essentially free of polyurethanes.

4. The method of claim 1, wherein the foam layer comprises a foam core disposed between a pair of adhesive skin layers, each adhesive skin layer comprising a pressure-sensitive adhesive.

5. The method of claim 4, wherein the foam core comprises a pressure-sensitive adhesive foam.

6. The method of claim 4, wherein the foam core is a syntactic foam containing glass microspheres.

7. The method of claim 4, wherein one or both of the adhesive skin layers comprises the acrylic polymer or silicone polymer.

8. The method of claim 1, wherein the foam layer comprises a pressure-sensitive adhesive foam, each adhesive surface being defined by respective opposing major surfaces of the pressure-sensitive adhesive foam.

9. The method of claim 1, wherein the channels have a depth ranging from 3 μm to 50 μm.

10. The method of claim 9, wherein the channels have a depth ranging from 10 μm to 30 μm.

11. The method of claim 1, wherein the channels define a volume ranging from 1×10³ μm to 1×10⁷ μm³ for any given 500 μm diameter circular area along the surface of the pressure-sensitive adhesive.

12. The method of claim 11, wherein the channels define a volume ranging from 1×10⁴ μm³ to 1×10⁶ μm³ for any given 500 μm diameter circular area along the surface of the pressure-sensitive adhesive.

13. An adhesive article for bonding glass or polymeric panels in structural glazing or architectural panel applications, comprising:
a foam layer having a pair of opposing major surfaces, the foam layer comprising an acrylic polymer or silicone polymer; and
an adhesive surface disposed on each of the opposing major surfaces, wherein a plurality of channels extend across at least one adhesive surface, wherein the channels are arranged at a pitch (average value of a distance between similar structural points of adjacent structures) of 400 μm or less, the at least one adhesive surface comprising a pressure-sensitive adhesive having a rheology enabling the plurality of channels to essentially disappear over time such that the adhesive article visually displays essentially 100% wet out at a temperature of 10° C. after the adhesive article is compressed by sufficient compressive force to induce flow of the pressure-sensitive adhesive.

14. A method of bonding a transparent or translucent glass or plastic panel using the adhesive article of claim 13, comprising:
disposing the adhesive article between the transparent or translucent glass or plastic panel and a substrate whereby the plurality of channels allows venting of entrapped air between the pressure-sensitive adhesive and the transparent or translucent glass or plastic panel; and
applying sufficient compressive force to the adhesive article to induce flow of the pressure-sensitive adhesive whereby the channels disposed on the at least one adhesive surface essentially disappear over time such that the adhesive article visually displays essentially 100% wet out at a temperature of 10° C. after the adhesive article is compressed by the compressive force.
